(19) United States
(12) Patent Application Publication
(10) Pub. No.: US 2016/0337224 A1
(43) Pub. Date: Nov. 17, 2016

(54) DUAL MEDIUM COMMUNICATIONS

(71) Applicant: QUALCOMM Incorporated, San Diego, CA (US)

(72) Inventors: Hassan Kaywan Afkhami, San Jose, CA (US); Purva Rameshchandra Rajkotia, Orlando, FL (US); Deniz Rende, San Jose, CA (US)

(21) Appl. No.: 14/709,038

(22) Filed: May 11, 2015

(51) Int. Cl. H04L 12/26; H04B 17/318

(52) U.S. Cl. CPC H04L 43/10; H04B 17/318; H04L 43/16

(57) ABSTRACT

A dual channel transmitter and a dual channel receiver are disclosed. The dual channel transmitter may determine to transmit an information signal to a network device and the dual channel receiver may determine to receive an information signal at the network device on either or both a wireless channel and a wireline channel. A guard interval controller may select a guard interval based at least in part on a determination of whether the information signal is to be transmitted or received on either or both the wireless channel and the wireline channel.

### TECHNICAL FIELD

Embodiments of the disclosed subject matter generally relate to the field of network communications and channels, and, more particularly, to network devices that utilize dual medium communication channels.

### BACKGROUND

Telecommunication networks enable computers and other electronic data processing devices to exchange information across communication channels. A channel may be a physical transmission medium such as a wireline, or may be a logical connection over a multiplexed medium such as an RF channel. A channel may be utilized to carry an information signal, for example a digital bit stream, from one or more network transmitters to one or more network receivers. Channels have various transmission characteristics including transmission capacity as may be measured by bandwidth.

Wireless channels that use overlapping frequency bands may be subject to mutual interference, resulting in data rate instability or failure of a connection. Wireline channels, such as powerline communication (PLC) links, may also be subject to link/channel degradation or failure. For example, the performance of a PLC channel may be significantly affected by the network structure within a building, by network traffic on a powerline transmission medium, or by noise induced into the powerline transmission medium.

Hybrid communication networks combine wireline and wired communication devices and channels. For example, a hybrid communication network may include wireless devices such as smartphones and other devices having wireless network interfaces. The hybrid communication network may further include wireline devices such as computers and other devices having wireline network interfaces (e.g., Ethernet). Communication between the wireline and wireless devices may be established using bridges which include both wireless and wireline network interfaces. Some network devices may include both wireless and wireline network interfaces (referred to as hybrid devices), If hybrid devices are directly connected by wireless or wireline transmission channels, they may directly communicate with each other. While different transmission media channels are used in hybrid networks, current hybrid network transmitters and receivers may not adequately utilize the coverage capability presented by the transmission media diversity.

### SUMMARY

Various embodiments for transmitting and receiving information signals are disclosed. In one embodiment, a dual channel transmitter may determine to transmit an information signal to a network device. The dual channel transmitter may include a transmit mode controller that may determine whether to transmit the information signal on either or both a wireless channel and a wireline channel. The dual channel transmitter may further include a guard interval controller that may select a transmit guard interval based on the determination of whether to transmit the information signal on either or both the wireless channel and the wireline channel.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram depicting a network environment in accordance with one embodiment;

FIG. 2 is a block diagram illustrating a dual channel transmitter in accordance with one embodiment;

FIG. 3 is a block diagram depicting a dual channel receiver that may be configured for diversity reception in accordance with one embodiment;

FIG. 4 is a flow diagram illustrating functions and processes performed to facilitate transmit mode selection and transmit guard interval selection in accordance with one embodiment;

FIG. 5 is a flow diagram depicting functions and processes performed to facilitate receive diversity in accordance with one embodiment; and

FIG. 6 depicts an example computer system having a hybrid network interface that may include a dual channel transmitter and/or a dual channel receiver.

### DESCRIPTION OF EMBODIMENT(S)

The description that follows includes exemplary systems, methods, techniques, instruction sequences and computer program products that embody techniques of the present disclosure. However, it is understood that the described embodiments may be practiced without these specific details. In other instances, well-known instruction instances, protocols, structures and techniques have not been shown in detail in order not to obfuscate the description.

The disclosure describes systems, devices, and methods for extending the reach of communication technologies by transmitting copies of the same information signal on diverse channel media. An information signal (e.g., a baseband bit stream) may be encoded within a carrier transmission signal (e.g., a wireless or wireline signal) that has been modulated and otherwise converted in transmission format to be transmitted across a particular channel medium, such as an RF channel or a PLC channel. For example, an information signal may be encoded within an RF transmission signal and a PLC transmission signal. Using the RF and PLC transmission signals, the information signal may be transmitted over an RF channel and a PLC channel. In this manner, the diversity for both transmitting and receiving, along with exploitation of different medium characteristics, facilitates the overall coverage and reach of the information signal.

In one embodiment, a wireless transmit interface and a wireline transmit interface receive and process a baseband information signal (e.g., RF baseband signal) to generate parallel wireless and wireline signals. The parallel wireless and wireline signals may be transmitted to a receiver having corresponding wireless and wireline receive interfaces.

By utilizing multiple channel media and corresponding frequency bands for transmission of baseband information signals, coverage can be improved. Also, the wireless and wireline signals can be combined to achieve diversity gains.

In one embodiment, a network device transmitter comprises a wireless transmit interface and a wireline transmit interface that each process a common baseband signal, and transmit resultant wireless and wireline signals each corresponding to the common baseband signal.

In another embodiment, a network device transmitter selectively transmits only a wireless signal, or only a wireline signal, or both the wireless and the wireline signal, wherein the wireless and wireline signals are each generated from the same baseband information signal. The criteria for selectively transmitting may include channel traffic conditions and/or the receiver configurations of network devices.

In an alternate embodiment, a network device receiver may comprise a wireless receive interface and a wireline receive interface for simultaneously receiving a wireless signal and a wireline signal that each include the same information signal. The receiver may either select, for processing, only the wireless or only the wireline signal based on absolute signal strength (e.g., one signal is below a specified threshold) or relative signal strength. Alternately, the receiver may select for processing the wireless signal and the wireline signal in combination based on the signal strength of the wireless and wireline signals.

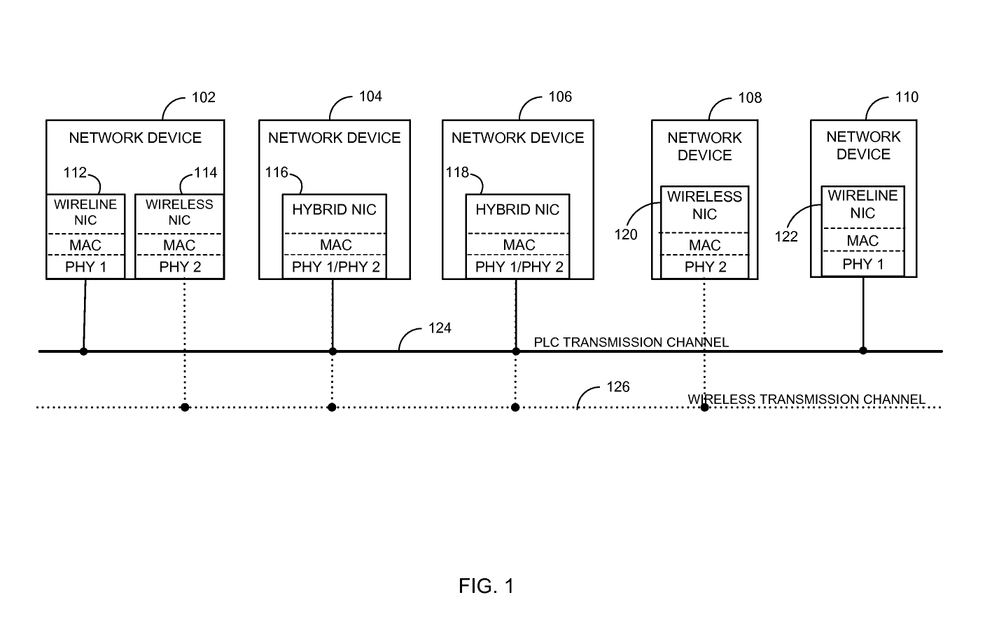

FIG. 1 is a block diagram depicting a network environment in accordance with one embodiment. The depicted network environment includes a network device 102 that includes a wireline network interface controller (NIC) 112 and a wireless NIC 114. Having both the wireline NIC 112 and the wireless NIC 114, the network device 102 may be classified as a hybrid device because it can transmit and receive information signals on two different transmission channels/media. In the depicted embodiment, the wireline NIC 112 includes a media access control (MAC) processing layer and a wireline physical layer, PHY 1, for transmitting and receiving information signals to and from other network devices on a powerline communication (PLC) transmission channel 124. The wireless NIC 114 includes a MAC processing layer and a wireless physical layer, PHY 2, for transmitting and receiving information signals to and from other network devices on a wireless transmission channel 126.

A network device 108 is communicatively connected to the wireless transmission channel 126. The network device 108 includes a wireless NIC 120 having a MAC processing layer and a PHY 2 wireless layer for transmitting and receiving information signals to and from other network devices on the wireless transmission channel 126. The network device 108 may transmit an information signal from its own wireless NIC 120 to the wireless NIC 114 of the network device 102. The network device 108 may also receive an information signal at the wireless NIC 120 from the wireless NIC 114 of the network device 102.

Another single network interface device, network device 110, is communicatively connected to the PLC transmission channel 124 via a wireline NIC 122. The wireline NIC 122 includes a MAC processing layer and a PHY 1 wireline layer for transmitting and receiving information signals to and from other network devices on the PLC transmission channel 124. For example, the network device 110 may transmit an information signal from the wireline NIC 122 to the wireline NIC 112 of the network device 102. The network device 110 may also receive an information signal at the wireline NIC 122 from the wireline NIC 112 of the network device 102.

In one embodiment, the PLC transmission channel 124 may comprise a wire or cable medium within a home or other building. For example, the PLC transmission channel 124 may comprise AC power distribution wiring within a home or other building. The PLC transmission channel 124 may provide physical transmission connectivity, such as within a wireline local area network (LAN) that communicatively connects multiple devices. The wireless transmission channel 126 may provide connectivity among devices within a wireless LAN. In one embodiment, the network device 102 may be configured as a hybrid bridge for communicatively connecting devices that may be included in a wireline LAN (e.g., network device 110) to devices that may be included in a wireless LAN (e.g., network device 108).

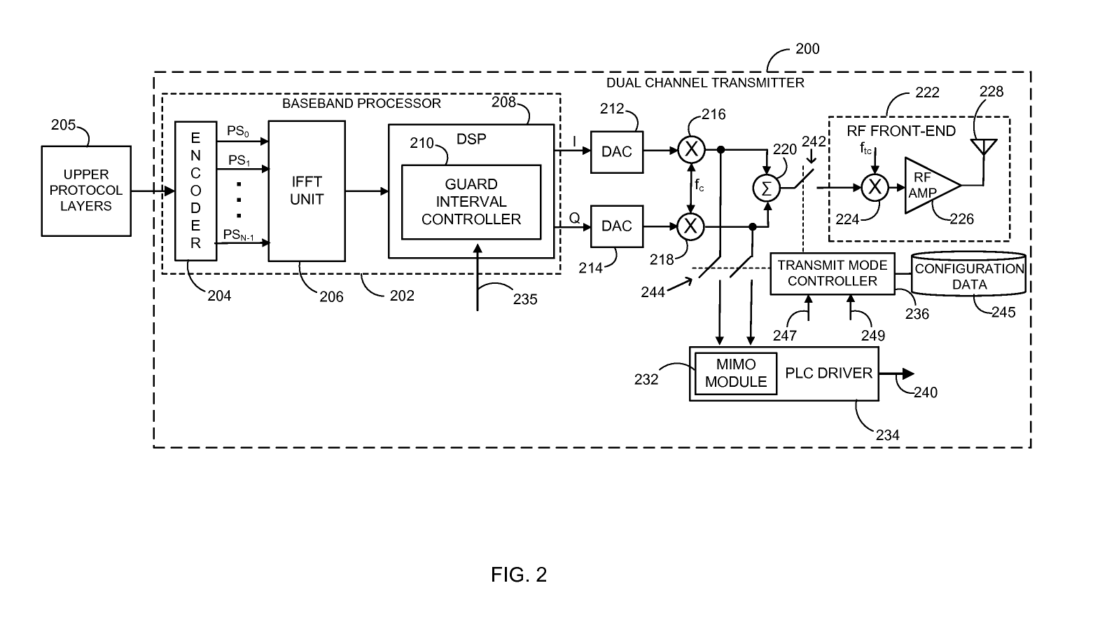

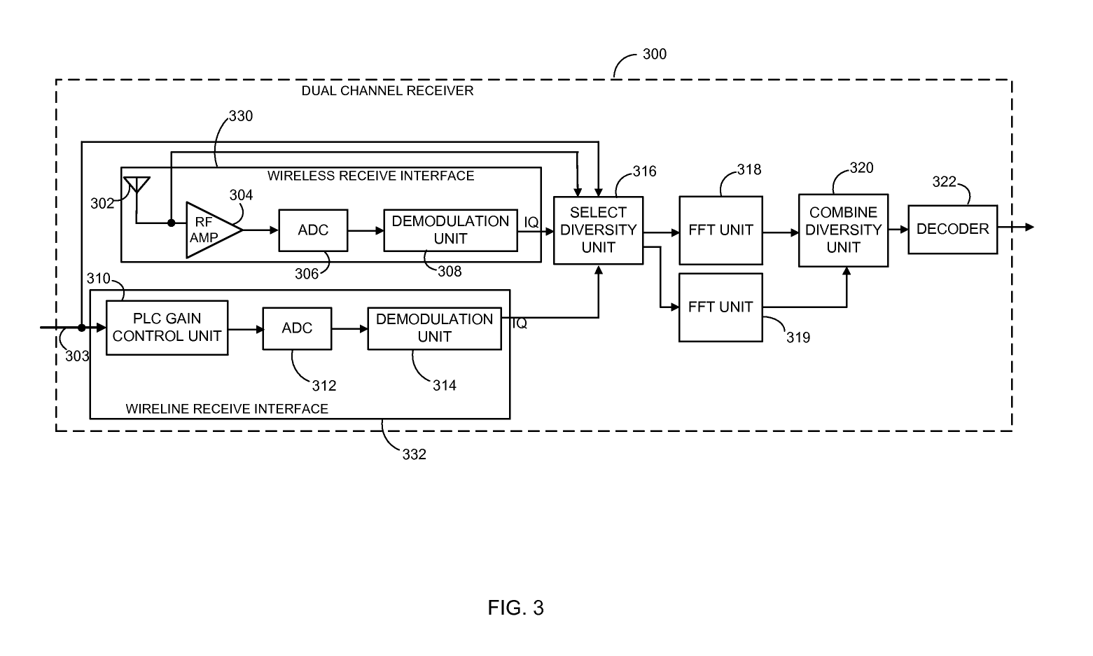

The depicted network environment further includes network devices 104 and 106. Network devices 104 and 106 include hybrid NICs 116 and 118, respectively. Each of the hybrid NICs 116 and 118 may be configured to transmit and receive information signals on both the wireline transmission channel 124 and the wireless transmission channel 126. Like the wireline NIC 112 and the wireless NIC 114 within the network device 102, the hybrid NICs 116 and 118 each include a MAC processing layer. However, each of the hybrid NICs 116 and 118 further includes a hybrid physical layer, PHY 1/PHY 2, that is configured to transmit or receive a given information signal on at least one wireline channel and at least one wireless channel. In an embodiment, and as described vis-à-vis FIGS. 2 and 3, the hybrid physical layers of each of the hybrid NICs 116 and 118 may include a dual channel transmitter. The hybrid physical layer of each of the hybrid NICs 116 and 118 may further include a dual channel receiver.

As will be further described vis-à-vis FIG. 2, each of the hybrid NICs 116 and 118 may include structure and/or logic configured as a hybrid, dual channel transmit interface having a wireline transmitter front-end and a wireless transmitter front-end. The wireline and wireless transmitter front-ends may each receive a common baseband information signal so that each may transmit respectively modulated (e.g., RF modulated and PLC modulated) copies of the same baseband information signal. As will be further described vis-à-vis FIG. 3, each of the NICs 116 and 118 may further include a hybrid, dual channel receive interface having a wireline receiver front-end and a wireless receiver front-end that each receive the same baseband information signal encoded within respective transmission signals on a wireline channel and wireless channel.

Configured as such, the network devices 104 and 106 may transmit and receive baseband information signals to and from any of the network devices on either the PLC transmission channel 124 or the wireless transmission channel 126. Furthermore, the network devices 104 and 106 may dynamically select a transmission mode for communicating with each other and with network devices, such as the network device 102.

FIGS. 2 and 3 depict, respectively, a dual channel transmitter and a dual channel receiver. The dual channel transmitter and dual channel receiver may comprise components within one or more of the PHY1, PH2, and PHY1/PH2 layers included in the network devices shown in FIG. 1. The dual channel transmitter depicted in FIG. 2 may include a transmit mode controller and a guard interval controller. The mode controller and guard interval controller can facilitate dual medium/channel transmissions to network devices. The dual channel receiver depicted in FIG. 3 may include a select diversity unit and a combine diversity unit. The select diversity unit and combine diversity unit can facilitate dual channel receiver performance. This disclosure will proceed with a more detailed discussion of FIG. 2.

FIG. 2 is a block diagram illustrating a hybrid, dual channel transmitter 200 in accordance with one embodiment. In the depicted embodiment, the dual channel transmitter 200 may apply orthogonal frequency-division multiplexing (OFDM) encoding. OFDM may be characterized in one aspect as encoding binary information on multiple carrier frequencies. The dual channel transmitter 200 may be classified as “hybrid” because it includes a wireless (e.g., RF) interface and a wireline (e.g., PLC) interface that each transmit a respectively formatted transmission copy of an information signal.

As shown in FIG. 2, the dual channel transmitter 200 includes a baseband processor 202 that receives a stream of baseband data bits from an upper protocol layer 205. The stream of baseband data bits may include an information signal which may be a baseband signal generated from the upper level protocol layer 205. The stream of baseband data bits may also include the address (e.g., IP and/or MAC address) of the network device which the upper level protocol layer 205 determined to transmit the information signal to.

The baseband processor 202 may include an encoder 204, an Inverse Fast Fourier Transform (IFFT) unit 206, and a digital signal processor (DSP) 208. The encoder 204 may receive the stream of data bits in segments of bits in a periodic manner, such as every T_{sym} seconds, where T_{sym} is a symbol interval. The encoder 204 may encode the bit segments and sub-divide the encoded bit segments into a number of sub-segments. The encoder 204 may also perform quadrature amplitude modulation encoding of the sub-segments to map the sub-segments into complex-valued points in a constellation pattern. Each complex-valued point in the constellation pattern may represent discrete values of phase and amplitude. The encoder 204 may then pass a corresponding sequence of frequency-domain sub-symbols, PS₀-PS_{N}, as input to the IFFT unit 206. The IFFT unit 206 may perform an inverse fast Fourier transform on the sequence of sub-symbols to generate time-domain OFDM symbols constituted of in-phase and quadrature-shifted digital components.

The time-domain OFDM symbols generated by the IFFT unit 206 may be received by the DSP 208, which may perform spectral shaping on the OFDM symbols. In the depicted embodiment, the DSP 208 may include a guard interval controller 210. The guard interval controller 210 may insert a transmit guard interval of length T_{g} as a prefix before each OFDM symbol. The transmit guard interval, which may also be referred to as a cyclic prefix, may be a repetition of part of the corresponding OFDM symbol. The transmit guard interval may be configured to be longer than a communication channel impulse response to prevent inter-symbol interference (ISI) between consecutive symbols. Different length of transmit guard intervals may be selected for different transmission media. For example, a transmit guard interval used for wireless transmission may be shorter than a transmit guard interval used for wireline transmission. Furthermore, different length of transmit guard intervals may be selected for different wireline media, such as PLC media and coaxial cable.

The baseband processor 202 may pass in-phase (I) and quadrature-shifted (Q) digital components of the time-domain symbols in two separate paths to a pair of digital-to-analog converters (DACs) 212 and 214, respectively. The DAC 212 may convert the in-phase (I) components of the time-domain OFDM symbols into analog signals which are used by a mixer 216 to modulate an intermediate frequency (IF) carrier signal and a corresponding quadrature-shifted IF signal each having a carrier frequency, f_{c} to generate in-phase and quadrature-shifted IF OFDM passband signals. Similarly, the DAC 214 may convert the quadrature-shifted (Q) components of the time-domain OFDM symbols into analog signals which are used by a mixer 218 to modulate an IF carrier signal and a corresponding quadrature-shifted IF signal each having a carrier frequency, f_{c} to generate in-phase and quadrature-shifted IF OFDM passband signals. The in-phase and quadrature-shifted IF OFDM passband signals generated by mixers 216 and 218 are then combined in a signal combiner 220 to form a composite baseband IF signal.

The composite baseband IF signal may be received by a wireless interface in the form of a RF front-end unit 222, In addition to other components, the RF front-end unit 222 may include an RF mixer 224, an RF amplifier 226, and an antenna 228. The RF mixer 224 receives and uses the composite baseband IF signal to modulate a transmit carrier signal having a frequency, f_{tc}, to generate an RF OFDM-modulated carrier signal that can be transmitted via the antenna 228 on a wireless channel.

The in-phase and quadrature-shifted IF OFDM passband signals generated by the mixers 216 and 218 may be received by a wireline interface such as a PLC driver 234. The PLC driver 234 may include a multiple-input multiple-output (MIMO) module 232. The MIMO module 232 may provide separate channels over which the PLC driver 234 can transmit the two IF OFDM passband signals on a wireline transmission medium 240.

In one embodiment, the dual channel transmitter 200 may further include a transmit mode controller 236. The transmit mode controller 236 may include components for determining a mode of transmission, such as wireless-only, wireline-only, or combined wireless and wireline (dual channel). For example, the transmit mode controller 236 may determine whether an information signal output from the baseband processor 202 (now comprising I and Q digital components of the original time domain information signal) should be transmitted only from the RF front-end unit 222, only from the PLC driver 234, or from both the RF front-end unit 222 and the PLC driver 234. The transmit mode controller 236 may use various mechanisms to implement transmit mode control. For example, a pair of switches 242 and 244 may be incorporated in or otherwise utilized by the transmit mode controller 236 to implement transmit mode control. In one embodiment, the transmit mode controller 236 may comprise components for issuing one or more control signals that actuate the switch 242 to either enable or disable the passing of the composite signal from the signal combiner 220 to the RF front-end unit 222. The transmit mode controller 236 may also comprise components for issuing one or more control signals that actuate the switch 244 to either enable or disable the passing of the modulated two-part information signal from the mixers 216 and 218 to the PLC driver 240.

The transmit mode selection (e.g., wireless-only, wireline-only, dual channel) may be based, at least in part, on the receive interface configuration of a receiving network device. In the depicted embodiment, the transmit mode controller 236 may access configuration data 245 to determine receiver and receive interface configurations within a network. The transmit mode controller 236 may determine to transmit an information signal to a network device and may access the configuration data 245 to identify a receiver configuration of the network device. For example, in response to determining that the network device includes only a wireless receive interface, the transmit mode controller 236 may select a wireless-only transmit mode. The transmit mode controller 236 can enable the wireless-only transmit mode by controlling the position of the switches 242 and 244 to pass the output from the mixers 216 and 218 only to the RF front-end unit 222. In some instances, the transmit mode controller 236 may select wireline-only transmit mode. For example, in response to determining that the network device includes only a wireline receive interface, the transmit mode controller 236 may select a wireline-only transmit mode. The transmit mode controller 236 can enable the wireline-only transmit mode by maintaining the switch 244 closed and opening the switch 242 to pass the output from the mixers 216 and 218 only to the PLC driver 234. In some instances, the transmit mode controller 236 may select dual channel transmit mode. For example, in response to determining that the network device includes both a wireless receive interface and a wireline receive interface, the transmit mode controller 236 may select a dual channel transmit mode. The transmit mode controller 236 can enable the dual channel transmit mode by maintaining both the switches 242 and 244 closed to pass the output from the mixers 216 and 218 to the RF front-end unit 222 and the PLC driver 234, respectively.

In some instances, the transmit mode selection may be based, at least in part, on the traffic levels detected on the wireless and/or wireline transmit channels. In the depicted embodiment, the transmit mode controller 236 may detect the traffic level on a wireless channel (e.g., the channel used by the antenna 228) from input received on a wireless channel traffic input 247. The transmit mode controller 236 may also detect the traffic level on a wireline channel (e.g., the PLC transmission medium 240) from input received on a wireline traffic input 249. The transmit mode controller 236 may select a transmit mode based on a combination of receiver configuration and traffic level information. For example, the transmit mode controller 236 may determine that the network device includes both a wireless and wireline receive interface that are not combined in a dual channel configuration. The transmit mode controller 236 may further determine whether the wireline traffic level exceeds a threshold. If the wireline traffic level exceeds the threshold, the transmit mode controller 236 may select a wireless-only transmit mode, and send a wireless-only transmit mode signal to the guard interval controller 210 via a signal input 235. If the wireline traffic level is below the threshold, the transmit mode controller 236 may select a wireline-only transmit mode, and send a wireline-only transmit mode signal to the guard interval controller 210. The guard interval controller 210 may adjust the transmit guard interval based on whether a wireless-only or a wireline-only transmit mode signal is received.

In one embodiment, the transmit mode selection may be utilized, at least in part, to determine the transmit guard interval to be inserted between symbols in an information signal within the baseband processor 202. For example, in response to determining that the receiving network device includes only a wireless receiver interface, the transmit mode controller 236 may send a transmit mode signal via a signal input 235 to the guard interval controller 210. The transmit mode signal may indicate a wireless-only transmit mode, a wireline-only transmit mode, or a dual channel transmit mode. The guard interval controller 210 may select the transmit guard interval based, at least in part, on the transmit mode selected by the transmit mode controller 236. For example, in response to the transmit mode signal indicating a wireless-only transmit mode, the guard interval controller 210 may select a transmit guard interval corresponding to an RF OFDM channel. In response to the transmit mode signal indicating a wireline-only transmit mode, the guard interval controller 210 may select a transmit guard interval corresponding to the physical medium (e.g., PLC wireline or coaxial cable) used for wireline transmission. In response to the transmit mode signal indicating a dual channel transmit mode, the guard interval controller 210 may select the longer guard interval of the wireline transmit medium.

FIG. 3 is a block diagram depicting a dual channel receiver 300 that may be configured for diversity reception in accordance with one embodiment. In the depicted embodiment, the dual channel receiver 300 may implement orthogonal frequency-division multiplexing (OFDM) decoding. As shown, the dual channel receiver 300 includes a wireless receive interface 330 that may comprise an antenna 302, an RF amplifier (RF amp) 304, an analog-to-digital converter (ADC) 306, and a demodulation unit 308. An RF OFDM signal received by the antenna 302 may be amplified by the RF amp 304. The amplified RF OFDM signal may be down converted to an intermediate frequency, then filtered, such as by a tuner (not depicted), prior to being sampled and digitized by the ADC 306. The demodulation unit 308 generates orthogonal signals in the form of an in-phase component signal (I signal) and a quadrature-shifted component signal (Q signal) from the digital signal received from the ADC 306.

The dual channel receiver 300 may further include a wireline receive interface 332. The wireline receive interface 332 may include, among other components, a PLC gain control unit 310, an ADC 312, and a demodulation unit 314. The PLC gain control unit 310 amplifies an IF OFDM signal received on a PLC transmission medium 303. After frequency down conversion (e.g., convert to baseband) and filtering such as by a tuner (not depicted), the amplified baseband OFDM signal is sampled and digitized by the ADC 312. The demodulation unit 314 generates orthogonal signals in the form of an in-phase component signal (I signal) and a quadrature-shifted component signal (Q signal) from the digital signal received from the ADC 312.

The dual channel receiver 300 may implement a two-part diversity reception mechanism to improve dual channel reception quality. In the depicted embodiment, the two-part mechanism may comprise a select diversity unit 316 and a combine diversity unit 320, The select diversity unit 316 may be utilized to selectively pass either or both a wireless signal and a wireline signal for further processing. For example, the select diversity unit 316 may selectively pass either a signal from the wireless receive interface 330 or a signal from the wireline receive interface 332 for further processing depending on absolute or relative signal strength. When the select diversity unit 316 passes the signals from both the wireless and wireline receive interfaces 330 and 332 for further processing, the combine diversity unit 320 may combine the signals to improve reception quality.

As shown in FIG. 3, the select diversity unit 316 may receive an IQ signal pair from the wireless receive interface 330. The select diversity unit 316 may further receive an IQ signal pair from the wireline receive interface. The select diversity unit 316 may select either or both of the IQ signal pairs to be further processed. The selection may be made using signal strength indicators received from each of the wireless and wireline receive interfaces 330 and 332. For example, the select diversity unit 316 may receive and sample a signal strength indicator (e.g., a signal indicating signal strength) from the antenna 302. The select diversity unit 316 may further receive and sample a signal strength indicator from the PLC transmission medium 303. The select diversity unit 316 may process the signal strength indicators to determine a signal strength associated with the wireless receive interface 330 (i.e., a wireless signal strength) and a signal strength associated with the wireline receive interface 332 (i.e., a wireline signal strength).

The select diversity unit 316 may compare the wireless signal strength with the wireline signal strength. The select diversity unit 316 may optionally compare the wireless signal strength with a threshold wireless signal strength. The select diversity unit 316 may also optionally compare the wireline signal strength with a threshold wireline signal strength. In response to determining that the wireless and/or the wireline signal strength exceed the respective threshold, the select diversity unit 316 may selectively pass one or both IQ signal pairs to corresponding Fast Fourier Transform (FFT) units 318 or 319. For example, if the select diversity unit 316 determines that the wireless signal strength exceeds a threshold wireless signal strength and that the wireline signal strength is below a threshold wireline signal strength, the select diversity unit 316 may pass the IQ signal pair from the demodulation unit 308 to the FFT unit 318. Similarly, if the select diversity unit 316 determines that the wireline signal strength exceeds a threshold wireline signal strength and that the wireless signal strength is below a threshold wireless signal strength, the select diversity unit 316 may pass the IQ signal pair from the demodulation unit 314 to the FFT unit 319.

In one embodiment, in response to determining that both the wireless and wireline signal strengths exceed the same or respective threshold signal strengths, the select diversity unit 316 may pass the IQ signal pair from the signal interface having the greater relative signal strength. In other embodiments, if neither the wireless signal strength nor the wireline signal strength exceed the same or respective threshold signal strengths, the select diversity unit 316 may pass both IQ signal pairs from the demodulation units 308 and 314 to the FFT units 318 and 319, respectively.

The FFT units 318 and 319 may receive the IQ signals from either or both the demodulation units 308 and 314 via the select diversity unit 316. For example, the select diversity unit 316 may pass the IQ signal pair from the demodulation unit 308 to the FFT unit 318 while not passing the IQ signal pair from the demodulation unit 314 to the FFT unit 319. Alternately, the select diversity unit 316 may pass the IQ signal pair from the demodulation unit 308 to the FFT unit 318 while also passing the IQ signal pair from the demodulation unit 314 to the FFT unit 319. The FFT units 318 and 319 may convert the IQ signals from time domain to frequency domain. When the select diversity unit 316 selects to pass IQ signal pairs from both the wireless and wireline receive interfaces, a combine diversity unit 320 may combine the IQ signal pairs received from the FFT units 318 and 319 in the frequency domain. A decoder 322 receives the output from the combine diversity unit 320 and may decode the frequency domain signals to recover the information signal as a time domain baseband bit stream. The output from the combine diversity unit 320 may be the combined IQ signal pairs or may be a single IQ signal received from only one of the FFT units 318 and 319.

While FIGS. 1-3 show components of some embodiments, this description continues with a discussion of flow diagrams showing operations of some embodiments.

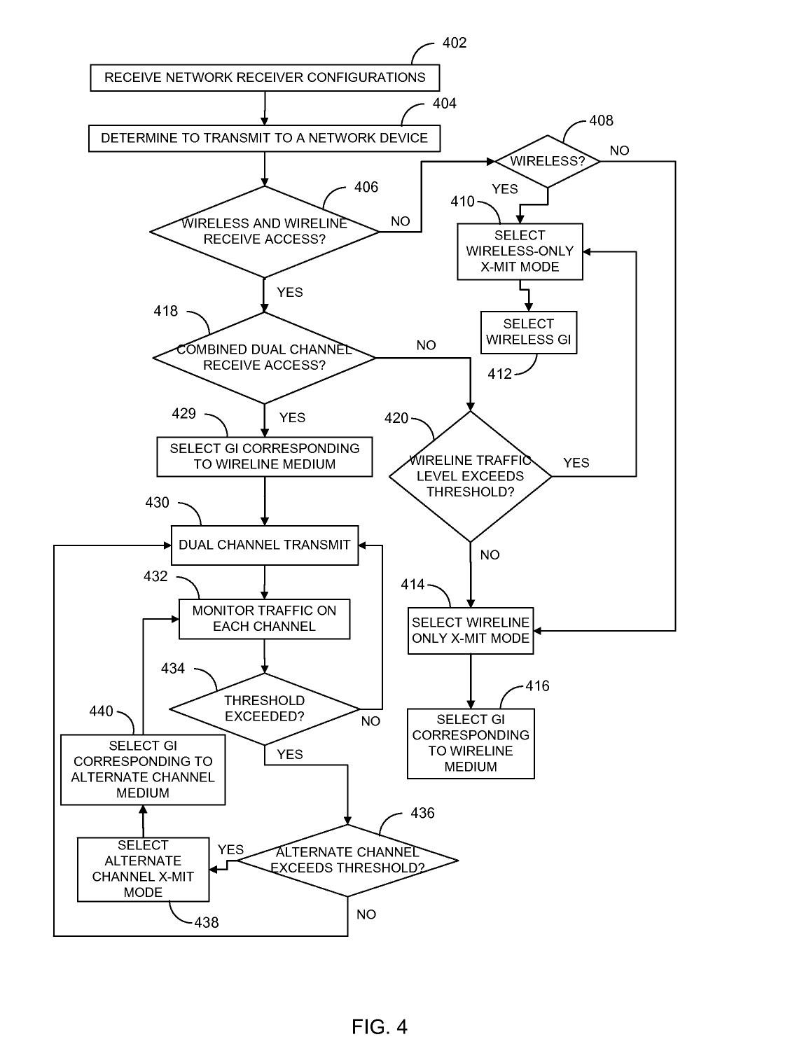

FIG. 4 is a flow diagram illustrating operations for transmit mode selection and guard interval selection, in accordance with one embodiment. The operations in FIG. 3 may be performed by a transmitter, such as the dual channel transmitter 200 depicted in FIG. 2. The process begins at block 402 with the transmitter receiving network receiver configuration information, such as may be collected from the configuration data 245 in FIG. 2. In one embodiment, the receiver configuration information may specify the types of receiver interfaces incorporated within the receivers of one or more network devices. For example, the receiver configuration information may specify that a network device includes a receiver having only a wireless receive interface. The receiver configuration information may specify that another network device includes a receiver having only a wireline receive interface. The receiver configuration information may specify that yet another network device includes a receiver having both a wireless and a wireline receive interface.

The flow continues at block 404 with the transmitter determining to transmit to a network device. At block 406, a transmit mode controller, such as the transmit mode controller 236, may determine whether the network device includes both wireless and wireline receive access. The transmit mode controller may access the receiver configuration information to find information corresponding to or otherwise associated with the network device. For example, the transmit mode controller may determine from the receiver configuration information that the network device, like the network devices 108 and 110 in FIG. 1, includes only wireless or only wireline receive access (block 408). In response to determining that the single channel receive access is wireless access, the transmit mode controller may select a wireless-only transmit mode (block 410). The transmit mode controller may send a wireless-only transmit mode signal to a guard interval controller, such as the guard interval controller 210. In response to receiving the wireless-only transmit mode signal, the guard interval controller may select and implement a guard interval corresponding to a wireless channel (blocks 412). In response to determining that the single channel receive access is wireline access (block 410), the transmit mode controller may select a wireline-only transmit mode (block 414). The transmit mode controller may send a wireline-only transmit mode signal to the guard interval controller. In response to receiving the wireline-only transmit mode signal, the guard interval controller may select and implement a guard interval corresponding to the wireline transmission medium (block 416).

Referring back to block 406, the transmit mode controller may determine from the receiver configuration information that the network device includes wireless and wireline receive access. For example, the transmit mode controller may determine that the network device, like the network device 102 in FIG. 1, includes a first network interface having a wireless receive interface and a second network interface having a wireline receive interface. Alternately, the transmit mode controller may determine that the network device, like the network devices 104 and 106 in FIG. 1, includes a wireless receive interface and a wireline receive interface combined within a single network interface and/or a single receiver. The dual channel receiver 300 is an example receiver that includes both a wireless receive interface and a wireline receive interface.

In response to determining that the wireless and wireline receive interfaces are not combined within a receiver (block 418), the transmit mode controller may further determine whether a network traffic level on a wireline transmission channel exceeds a threshold level (block 420). If the network traffic level on the wireline medium does not exceed the threshold level, the transmit mode controller may select a wireline-only transmit mode (block 414). The transmit mode controller may send a wireline-only transmit mode signal to the guard interval controller. In response to receiving the wireline-only transmit mode signal, the guard interval controller may select and implement a guard interval corresponding to the wireline medium (block 416).

Referring back to block 420, if the network traffic level on the wireline medium exceeds the threshold level, the transmit mode controller may select a wireless-only transmit mode (block 410). The transmit mode controller may send a wireless-only transmit mode signal to the guard interval controller. In response to receiving the wireless-only transmit mode signal, the guard interval controller may select and implement a guard interval corresponding to the wireless channel (block 412).

Referring back to block 418, if the wireless and wireline receive interfaces of the network device are combined within a receiver, the transmit mode controller may select a dual channel transmit mode, and send a corresponding dual channel transmit mode signal to the guard interval controller. In response to receiving the dual channel transmit mode signal, the guard interval controller may select a guard interval corresponding to the wireline medium (block 429). The dual channel transmitter may begin transmitting the information signal to the network device from a wireless transmit interface and a wireline transmit interface (block 430). The information signal may comprise many varieties of data or message transmission. For example, the information signal may comprise a continuously transmitted data stream.

While transmitting, the transmit mode controller may monitor communications traffic on each of the wireless and wireline channels (block 432). For example, the transmit mode controller may monitor the wireless and wireline channel traffic by detecting inputs from the wireless channel traffic input 247 and the wireline traffic input 249 in FIG. 2. Dual channel transmission may continue while the traffic levels on both the wireless and wireline channels do not exceed a respective wireless and wireline threshold (block 434). If the traffic level on either but not both the wireless and/or wireline channels exceeds the threshold level (block 436), the transmit mode controller may select the non-exceeding channel as the exclusive transmit mode (block 438). For example, if the traffic level on the wireless channel exceeds a wireless traffic threshold and the traffic level on the wireline channel does not exceed a wireline threshold, the transmit mode controller may select the wireline-only transmit mode. The transmit mode controller may also send a corresponding wireline-only transmit mode signal to the guard interval controller. In response to receiving the transmit mode select signal (wireless-only or wireline-only), the guard interval controller may select and implement a transmit guard interval that corresponds to the channel for which the threshold has not been exceeded (block 440). In response to determining that the traffic levels on both the wireless and/or wireline channels exceed the respective threshold levels, the dual channel transmitter may continue to transmit the information signal on both channels (blocks 436 and 430).

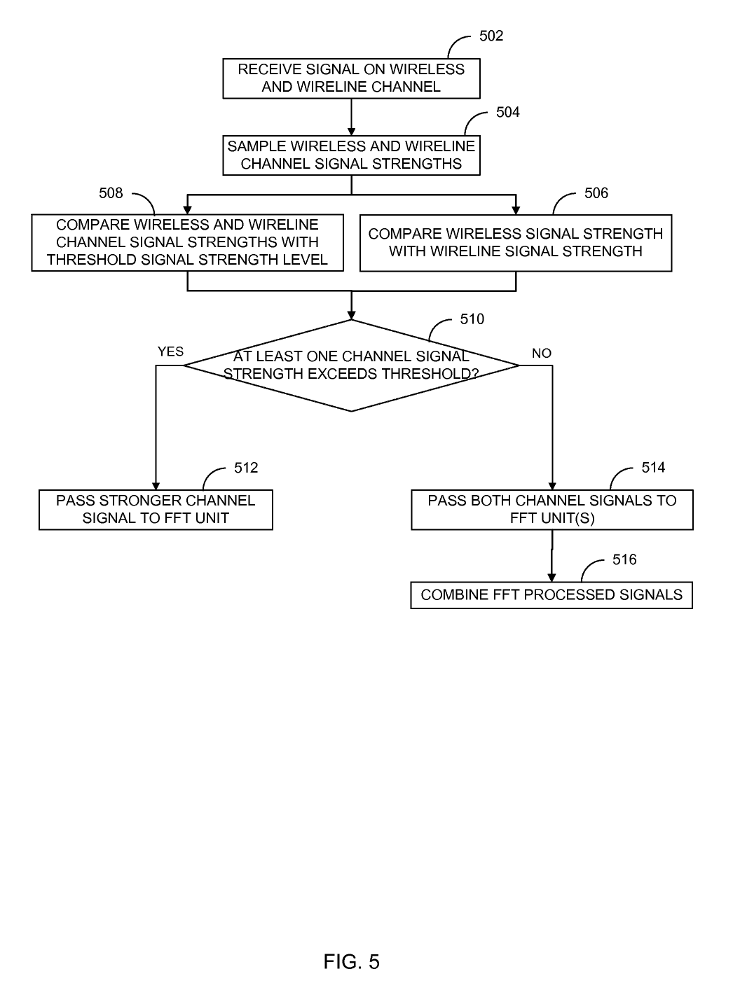

FIG. 5 is a flow diagram depicting operations for facilitating receive diversity in accordance with one embodiment. The operations depicted in FIG. 5 may be performed by a dual channel receiver, such as the dual channel receiver 300 in FIG. 3, configured to include a select diversity unit and a combine diversity unit. The select diversity unit may be configured to receive a wireless receive interface signal from a first demodulation unit and a wireline receive signal from a second demodulation unit. The select diversity unit may also be configured to pass either or both the wireless receive interface signal and/or the wireline receive interface signal to a first and a second frequency domain converter. The process begins at block 502 with the dual channel receiver receiving an information signal on a wireless receive channel and a wireline receive channel. At block 504, a select diversity unit may sample the signal strengths of the information signal as received on the wireless and wireline channels. In one embodiment, the select diversity unit may obtain and process signal strength indicators from each of a wireless and a wireline receive interface. For example, the signal strength indicators may be sampled from an RF antenna and from a wireline medium input. The signal strength indicators may be processed to determine a wireless channel signal strength and a wireline channel signal strength.

At block 506, the select diversity unit may compare the wireless channel signal strength with the wireline channel signal strength. The select diversity unit may also compare each of the wireless channel signal strength and the wireline channel signal strength with one or more threshold signal strengths (block 508). For example, the select diversity unit may compare both the wireless channel signal strength and the wireline channel signal strength with one signal strength threshold. As another example, the select diversity unit may compare the wireless channel signal strength with a first signal strength threshold and may compare the wireline channel signal strength with a second signal strength threshold.

If one of the wireless or the wireline signal strengths exceeds a signal strength threshold and the other does not, the select diversity unit may pass a receive interface signal from a corresponding demodulation unit to a corresponding frequency domain converter. For example, if the select diversity unit determines that the wireless signal strength exceeds a signal strength threshold and that the wireline signal strength is below a signal strength threshold, the select diversity unit may pass a signal pair from a wireless receive interface demodulation unit to a corresponding frequency domain converter. In response to determining that both of the wireless and wireline signal strengths exceed the same or respective signal strength thresholds, the select diversity unit may pass a signal from whichever demodulation units belongs to the signal interface having the greater signal strength (blocks 510 and 512). For example, if both the wireless signal strength and the wireline signal strength exceed a signal strength threshold, the diversity select unit may pass a wireline receive interface signal in response to determining that the wireline signal strength is greater than the wireless signal strength. In an embodiment, if neither the wireless signal strength nor the wireline signal strength exceed a signal strength threshold, the select diversity unit may pass signals from both demodulation units to the respective frequency domain converters (block 514). As shown at block 516 the output signals from the frequency domain converters may be combined by a signal combiner.

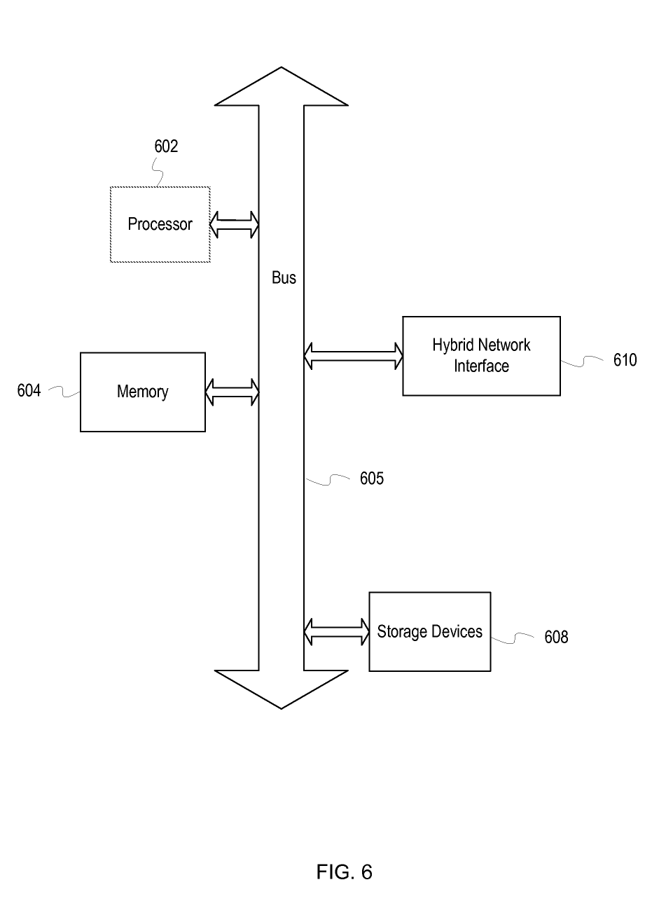

FIG. 6 depicts an example computer system having a hybrid network interface 610 that may include a dual channel transmitter and/or a dual channel receiver. For example, hybrid network interface 610 may comprise transmitter and receiver components and devices included in a wireless RF interface, a PLC interface, an Ethernet interface, a Frame Relay interface, SONET interface, etc. The computer system further includes a processor 602 (possibly including multiple processors, multiple cores, multiple nodes, and/or implementing multi-threading, etc.). The computer system includes memory 604 which may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of non-transitory machine-readable storage media. The computer system also includes a bus 605 (e.g., PCI, ISA, PCI-Express, HyperTransport®, InfiniBand®, NuBus, etc.) and a storage device(s) 608 (e.g., optical storage, magnetic storage, etc.). The hybrid network interface 610 embodies functionality to implement features described above with reference to FIGS. 1-5. The hybrid network interface 610 may perform operations that facilitate dual channel signal transmission and reception. The hybrid network interface 610 may perform diversity transmission and reception in a manner such that a transmit guard interval is optimally selected. Any one of these operations may be partially (or entirely) implemented in hardware and/or on processor 602. For example, the functionality may be implemented with an application specific integrated circuit, in logic implemented in processor 602, in a co-processor on a peripheral device or card, etc. Further, realizations may include fewer or additional components not illustrated in FIG. 6 (e.g., additional network interfaces, peripheral devices, etc.).

It should be understood that FIGS. 1-6 are examples meant to aid in understanding embodiments and should not be used to limit embodiments or limit scope of the claims. Embodiments may perform additional operations, fewer operations, operations in a different order, operations in parallel, and some operations differently. In some embodiments, the hybrid network interface 610 can implement the operations of FIGS. 4 and 5 individually or in combination.

As will be appreciated by one skilled in the art, aspects of the disclosed subject matter may be embodied as a system, method or computer program product. Accordingly, embodiments of the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the disclosed subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosed subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the disclosed subject matter.

While the embodiments are described with reference to various implementations and exploitations, it will be understood that these embodiments are illustrative and that the scope of the disclosed subject matter is not limited to them.

1. A method for transmitting an information signal from a dual channel transmitter, said method comprising:
determining to transmit the information signal to a network device on a wireless channel, a wireline channel, or a combination thereof; and
selecting a transmit guard interval based, at least in part, on said determination.

2. The method of claim 1, further comprising:
determining that the network device has wireless receive access, wireline receive access, or a combination thereof.

3. The method of claim 2, further comprising:
in response to a determination that the network device has only wireless receive access, determining to transmit the information signal on only the wireless channel; and
selecting the transmit guard interval based, at least in part, on said determination to transmit the information signal on only the wireless channel.

4. The method of claim 2, further comprising:
in response to a determination that the network device has only wireline receive access, determining to transmit the information signal on only the wireline channel; and
selecting the transmit guard interval based, at least in part, on a transmit medium of the wireline channel.

5. The method of claim 2, further comprising:
In response to a determination that the network device has both wireless receive access and wireline receive access, determining to transmit the information signal on both the wireless channel and the wireline channel.

6. The method of claim 5, further comprising:
selecting the transmit guard interval based at least in part on a transmit medium of the wireline channel; and
transmitting the information signal having the selected transmit guard interval via the wireless channel and the wireline channel.

7. The method of claim 1, further comprising:
monitoring signal traffic on the wireless channel and the wireline channel.

8. The method of claim 7, further comprising:
in response to the signal traffic on the wireless channel exceeding a wireless channel threshold, determining to transmit the information signal on the wireline channel.

9. The method of claim 7, further comprising:
in response to the signal traffic on the wireline channel exceeding a wireline channel threshold, determining to transmit the information signal on the wireless channel.

10. A dual channel transmitter, comprising:
upper level protocol layers configured to determine to transmit an information signal to a network device;
a transmit mode controller configured to determine to transmit the information signal on a wireless channel, a wireline channel, or a combination thereof; and
a guard interval controller configured to select a transmit guard interval based, at least in part, on said determination.

11. The dual channel transmitter of claim 10, wherein said transmit mode controller is further configured to determine the network device has wireless receive access, wireline receive access, or a combination thereof.

12. The dual channel transmitter of claim 11, wherein the guard interval controller is further configured to select the transmit guard interval based, at least in part, on the wireless channel, in response to a determination that the network device has only wireless receive access.

13. The dual channel transmitter of claim 11, wherein the guard interval controller is further configured to select the transmit guard interval based, at least in part, on a transmit medium of the wireline channel, in response to a determination that the network device has only wireline receive access.

14. The dual channel transmitter of claim 10, wherein the transmit mode controller is further configured to,
determine the network device includes a wireless receive interface and a wireline receiver interface that are configured to receive a same information signal, and
transmit the information signal on the wireless channel and the wireline channel in response to a determination that the network device includes the wireless receive interface and the wireline receive interface that are configured to receive a same information signal.

15. The dual channel transmitter of claim 14, wherein the guard interval controller is further configured to select the transmit guard interval based, at least in part, on a transmit medium of the wireline channel.

16. The dual channel transmitter of claim 10, wherein the transmit mode controller is further configured to monitor signal traffic on the wireless channel and the wireline channel.

17. The dual channel transmitter of claim 16, wherein the transmit mode controller is further configured to determine to transmit the information signal on the wireline channel, in response to the signal traffic on the wireless channel exceeding a wireless channel threshold.

18. The dual channel transmitter of claim 16, wherein the transmit mode controller is further configured to transmit the information signal on the wireless channel, in response to the signal traffic on the wireline channel exceeding a wireline channel threshold.

19. A method for receiving an information signal at a network device, said method comprising:
receiving a wireless signal at a wireless receive interface and a wireline signal on a wireline receive interface;
determining a first signal strength of the wireless signal;
determining a second signal strength of the wireline signal; and
selecting either or both the wireless and the wireline signals for further processing based, at least in part, on the determined first and second signal strengths.

20. The method of claim 19, further comprising:
comparing the first signal strength with a first signal strength threshold; and
comparing the second signal strength with a second signal strength threshold.

21. The method of claim 20, wherein said selecting either or both the wireless and the wireline signal further comprises:
selecting both the wireless and the wireline signal in response to determining that the first signal strength does not exceed the first signal strength threshold and that the second signal strength does not exceed the second signal strength threshold.

22. The method of claim 21, further comprising combining the selected wireless and the wireline signals within the information signal.

23. A dual channel receiver comprising:
a wireless receive interface configured to receive a wireless signal;
a wireline receive interface configured to receive a wireline signal;
a select diversity unit configured to,
determine a first signal strength of the wireless signal and a second signal strength of the wireline signal; and
select either or both the wireless and the wireline signals for further processing based, at least in part, on the determined first and second signal strengths.

24. The dual channel receiver of claim 23, wherein the select diversity unit is further configured to,
compare the first signal strength with a first signal strength threshold; and
compare the second signal strength with a second signal strength threshold.

25. The dual channel receiver of claim 24, wherein the select diversity unit is further configured to select both the wireless and the wireline signal for further processing in response to determining that the first signal strength does not exceed the first signal strength threshold and that the second signal strength does not exceed the second signal strength threshold.

26. The dual channel receiver of claim 23, further comprising:
a combine diversity unit configured to combine the selected wireless signal and the selected wireline signals within an information signal.
